(19) United States
(12) Patent Application Publication
(10) Pub. No.: US 2025/0030055 A1
(43) Pub. Date: Jan. 23, 2025

(54) BATTERY ELECTRODE MANUFACTURING DEVICE AND BATTERY ELECTRODE MANUFACTURING METHOD

(71) Applicant: APB CORPORATION, Tokyo (JP)

(72) Inventors: Hideaki HORIE, Tokyo (JP); Kenichiro ENOKI, Kyoto (JP); Yusuke NAKASHIMA, Kyoto (JP); Kotaro NASU, Kyoto (JP)

(21) Appl. No.: 18/714,445

(22) PCT Filed: Nov. 29, 2022
(86) PCT No.: PCT/JP2022/043874

§ 371 Date: May 29, 2024

(30) Foreign Application Priority Data
Nov. 30, 2021 (JP) 2021-193916
Dec. 27, 2021 (JP) 2021-211989

(51) Int. Cl. H01M 10/058; H01M 4/04

(52) U.S. Cl. CPC H01M 10/058; H01M 4/0435

(57) ABSTRACT

A battery electrode manufacturing device includes: a powder supply device that supplies an electrode composition as a wet powder containing an electrode active material and an electrolytic solution to a strip-shaped base film; a conveyance mechanism that conveys the base film on which the electrode composition supplied from the powder supply device is placed; a preliminary press device, that includes a pair of preliminary rollers, and that compresses the electrode composition supplied from the powder supply device to the base film; and a press device having a pair of rollers that compress the electrode composition after compression by the preliminary press device. The preliminary press device includes a plurality of the pair of preliminary rollers that compress the electrode composition in stages, and the gap between the pair of preliminary rollers is set to be larger than the gap between the pair of rollers.

### FIELD OF THE INVENTION

This invention relates to a battery electrode manufacturing device and a battery electrode manufacturing method.

### BACKGROUND ART

Lithium-ion batteries are high-capacity secondary batteries and have come to be widely used in a variety of usages. For example, an electrode of a lithium-ion secondary battery comprises an active material layer formed on a current collector (refer to Patent References 1 and 2, for example).

Patent Reference 1 discloses a method for manufacturing a lithium polymer secondary battery using a lithium-ion conductive gel as a solid electrolyte. In Patent Reference 1, for example, a container holding an electrode (active material layer), which is immersed with a lithium-ion conductive gel precursor solution, is flattened by a roller, and then the precursor solution is hardened. Due to this, a flat lithium-ion conductive gel layer is formed on the electrode surface.

In Patent Reference 2, composite particles (granules) containing an active material and a binder, are supplied as an electrode composition to a sheet-like current collector that is a strip-like base film, and the electrode composition is pressed by a roll press. Due to this, an active material layer is formed. For example, in Patent Reference 2, the electrode composition is rolled once by a pair of rollers as a first rolling process, and then the electrode composition is rolled in multiple stages by a plurality of pairs of rollers as a second rolling process. Due to this, a high-density active material layer is formed.

### CITATION LIST

### Patent Literature

[Patent Reference 1] Publication of Japanese Patent No. 4188668
[Patent Reference 2] Publication of Japanese Patent No. 6633866

### BRIEF SUMMARY OF THE INVENTION

### Problems that Invention is to Solve

In Patent Reference 2, the first rolling process is performed using a large diameter roller and the second rolling process is performed using a small diameter roller. However, depending on the state of the electrode composition before it is pressed, if a large-diameter roller is used for the first compression, the electrode composition may not be compressed in a flat state and may be compressed in an uneven state. In this case, a high-density active material layer cannot be formed so that the electronic conductivity is decreased.

The present invention has been made in view of the above-mentioned problems and has an objective to provide a battery electrode manufacturing device and a battery electrode manufacturing method, which can form a high-density active material layer and can improve electronic conductivity.

### Means to Solve the Problems

In order to achieve the objective, a battery electrode manufacturing device of this invention comprises: a powder supply unit that supplies a wet powder containing an electrode active material and an electrolytic solution to a strip-shaped base film; a conveyance unit that conveys the base film on which the wet powder supplied from the powder supply unit is placed; a preliminary press unit, that includes a pair of preliminary rollers, and that compresses the wet powder supplied from the powder supply unit to the base film; and a press unit having a pair of rollers that compress the wet powder after compression by the preliminary of press unit. The preliminary press unit includes a plurality the pair of preliminary rollers that compress the wet powder in stages, and the gap between the pair of preliminary rollers is set to be larger than the gap between the pair of rollers.

### Effects of the Invention

The battery electrode manufacturing device and the battery electrode manufacturing method, according to this invention, can form a high-density active material and layer can improve electronic conductivity.

### BRIEF DESCRIPTION OF DRAWINGS

FIG. 1 is a schematic cross-sectional diagram of a single cell, which is manufactured by a battery electrode manufacturing device of an embodiment.

FIG. 2 is a schematic diagram showing the battery electrode manufacturing device of the embodiment.

FIG. 3 is a diagram showing the preliminary press device and the press device included in the battery electrode manufacturing device of the embodiment.

FIG. 4 is a diagram schematically showing the compression process of the electrode composition by the preliminary press device and the press device.

FIG. 5 is a diagram showing an example of the rotation mechanism included in the preliminary press device.

FIG. 6 is a schematic diagram of a battery electrode manufacturing device of a first variation.

FIG. 7 is a schematic diagram of a battery electrode manufacturing device of a second variation.

FIG. 8 is a schematic diagram of a battery electrode manufacturing device of a third variation.

FIG. 9 is a perspective diagram showing the width presser and the press device according to the third variation.

FIG. 10 is a diagram showing details of the width presser according to the third variation.

### DESCRIPTION OF EMBODIMENTS

### Embodiment

Hereinafter, the embodiment of the present invention will be explained by referring to the figures. Herein, in the figures used in the following explanations, some characteristic parts may be enlarged for the purpose of emphasizing said characteristic parts. Therefore, the dimensional ratios of each component are not necessarily the same as the real ones. In addition, for the same purpose, a part of the present invention may be omitted from the figures.

### <Assembled Battery (Secondary Battery)>

The battery electrode manufacturing device and the battery electrode manufacturing method of the embodiment are applied, for example, to the manufacture of lithium-ion batteries. Lithium-ion batteries can be used, for example, in the form of a battery pack whose voltage and capacity can be adjusted with an assembled battery that is made into a module by combining lithium-ion cells (also written as single cell or battery cell) or by combining multiple such assembled batteries.

### <Single Cell (Battery Cell)>

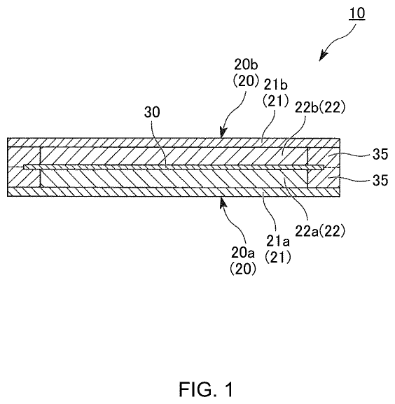

FIG. 1 is a schematic cross-sectional view of a single cell 10. It is possible to produce the above assembled battery by combining a plurality of single cells 10. For example, the single cell 10 comprises a cathode 20a and an anode 20b as two electrodes 20 (battery electrodes), and a separator 30.

The separator 30 is arranged between the cathode 20a and the anode 20b. In terms of the assembled battery, a plurality of single cells 10 are stacked where the cathode 20a and the anode 20b are facing at the same direction.

The separator 30 holds an electrolyte. Thereby, the separator 30 functions as an electrolyte layer. The separator 30 is arranged between the electrode active material layers 22 of the cathode 20a and the anode 20b, and prevents them from contacting with each other. Thereby, the separator 30 functions partition between the cathode 20a and the anode 20b.

Examples of the electrolyte held in the separator 30 include an electrolytic solution or a gel polymer electrolyte. The separator 30 ensures high lithium-ion conductivity by using these electrolytes. Examples of the form of the separator include a porous sheet separator made of a polymer or fiber that absorbs and retains the electrolyte, a nonwoven fabric separator, and the like.

The cathode 20a and the anode 20b each comprise a current collector 21, an electrode active material layer 22, and a frame member 35. The electrode active material layer 22 and the current collector 21 are arranged in this order from the separator 30 side. The frame member 35 is frame-shaped (annular). The frame member 35 surrounds the electrode active material layer 22. The frame member 35 of the cathode 20a and the frame member 35 of the anode 20b are welded together and integrated. In the following description, when the electrode active material layers 22 of the cathode 20a and the anode 20b are to be distinguished from each other, they will be referred to as a cathode active material layer 22a and an anode active material layer 22b, respectively.

### <Specific Example of Cathode Current Collector>

As the cathode current collector constituting the cathode current collector layer 21a, a current collector used in a known lithium-ion cell can be used. For example, as the cathode current collector, a known metal current collector and a resin current collector composed of a conductive material and a resin (resin current collector described in JP 2012-150905 and WO 2015/005116, etc.), can be used. The cathode current collector constituting the cathode current collector layer 21a is preferably a resin current collector from the viewpoint of battery characteristics and the like.

Examples of metal current collectors include copper, aluminum, titanium, nickel, tantalum, niobium, hafnium, zirconium, zinc, tungsten, bismuth, antimony, alloys containing one or more of these metals, and one or more metal materials selected from the group consisting of stainless steel alloys. These metal materials may be used in the form of a thin plate, metal foil, or the like. Furthermore, a substrate, which is made of a material other than the above-described metal material, on which the above-mentioned metal material is formed by sputtering, electrodeposition, coating or the like, may be used as the metal current collector.

The resin current collector preferably contains a conductive filler and a matrix resin. Examples of the matrix resin include polyethylene (PE), polypropylene (PP), polymethylpentene (PMP), etc., but are not particularly limited. The conductive filler is not particularly limited as long as it is selected from materials having conductivity. The conductive filler may be a conductive fiber having a fibrous shape.

The resin current collector may contain other components (dispersant, crosslinking accelerator, crosslinking agent, coloring agent, ultraviolet absorber, plasticizer, etc.) in addition to the matrix resin and the conductive filler. Further, a plurality of resin current collectors may be stacked and used, or a resin current collector and a metal foil may be stacked and used.

The thickness of the cathode current collector layer 21a is not particularly limited, but is preferably 5 to 150 μm. When a plurality of resin current collectors are stacked and used as the cathode current collector layer 21a, the total thickness after stacking is preferably 5 to 150 μm. The cathode current collector layer 21a can be obtained, for example, by molding a conductive resin composition obtained by melt-kneading a matrix resin, a conductive filler, and an optional filler dispersant into a film-shaped composition by a known method.

### <Specific Examples of Cathode Active Materials>

The cathode active material layer 22a is preferably a non-bound body of a mixture containing the cathode active material. Herein, a non-bound body means that the position of the cathode active material in the cathode active material layer is not fixed, and the cathode active materials and the cathode active material and the current collector are irreversibly fixed from each other. When the cathode active material layer 22a is a non-bound body, since the cathode active materials are not irreversibly fixed to each other, the interface between the cathode active materials can be separated without mechanical damages. Therefore, even when stress is applied to the cathode active material layer 22a, the transfer of the cathode active material can prevent destruction of the cathode active material layer 22a, which is preferable. The cathode active material layer 22a, which is a non-bound body, can be obtained by a method of changing the cathode active material layer 22a to the cathode active material layer 22a that contains a cathode active material and an electrolytic solution, and that does not contain a binder. Here, in this specification, the binder refers to an agent that cannot reversibly fix the cathode active material to each other and the cathode active material to the current collector, and known solvent-drying type binders for lithium ion batteries such as starch, polyvinylidene fluoride, polyvinyl alcohol, carboxymethyl cellulose, polyvinylpyrrolidone, tetrafluoroethylene, styrene-butadiene rubber, polyethylene and polypropylene may be exemplified. These binders are used by being dissolved or dispersed in a solvent, and are solidified by volatilizing and distilling off the solvent without the surface becoming sticky. Therefore, it is not possible to reversibly fix the cathode active materials, or the cathode active material and the current collector.

Examples of the cathode active material include a composite oxide of lithium and a transition metal, a composite oxide having two kinds of transition metal elements, a composite oxide having three or more kinds of metal elements and the like, but are not particularly limited.

The cathode active material may be a coated cathode active material in which at least a part of the surface is covered with a coating material containing a polymer compound. When the outer periphery of the cathode active material is covered with a coating material, volume change of the cathode is alleviated, and expansion of the cathode can be suppressed.

As the polymer compound constituting the coating material, those described as a resin for coating active material mentioned in JP 2017-054703 and WO 2015/005117 can be suitably used.

The coating material may contain a conductive assistant. As the conductive assistant, the same conductive filler contained in the cathode current collector layer 21a, can be suitably used.

The cathode active material layer 22a may contain adhesive resin. As the adhesive resin, those described as a mixture of a resin for coating non-aqueous secondary battery active materials, which is mentioned in Japanese Unexamined Patent Application, First Publication No. 2017-054703, and a small amount of organic solvent with adjusting the glass transition below room temperature temperature, and as an adhesive mentioned in Japanese resin Unexamined Patent Application, First Publication No. H10-255805 or the like, can be used. Here, the adhesive resin means a resin having pressure-sensitive adhesiveness (an adhering property obtained by applying a slight pressure without using water, solvent, heat, or the like) without solidifying even in a case where a solvent component is volatilized and dried. On the other hand, a solution-drying type binder for an electrode, which is used as a binding material, means a binder that dries and solidifies in a case where a solvent component is volatilized, thereby firmly adhering and fixing active materials to each other. As a result, the binder (the solution-drying type electrode binder) and the adhesive resin are different materials.

The cathode active material layer 22a may contain an electrolytic solution that contains an electrolyte and a non-aqueous solvent. As the electrolyte, those used in the known electrolytic solution can be used. As the non-aqueous solvent, those used in known electrolytic solutions (for example, phosphoric acid esters, nitrile compounds, etc., mixtures thereof, etc.) can be used. For example, a mixture of ethylene carbonate (EC) and dimethyl carbonate (DMC) or a mixture of ethylene carbonate (EC) and propylene carbonate (PC) can be used.

The cathode active material layer 22a may contain a conductive assistant. As the conductive assistant, a conductive material similar to the conductive filler contained in the cathode current collector layer 21a, can be suitably used.

The thickness of the cathode active material layer 22a is not particularly limited, but from the viewpoint of battery performance, it is preferably 150 to 600 μm, more preferably 200 to 450 μm.

In this embodiment, a cathode composition, which is supplied to form the cathode active material layer 22a, is a wet powder containing a cathode active material and non-aqueous electrolytic solution. Also, it is preferable that the wet powder is in a condition of pendula or funicular.

The ratio of the non-aqueous electrolytic solution in the wet powder is not particularly limited, but if the pendula or funicular condition is necessary, in terms of the cathode, it is preferable that the proportion of the non-aqueous electrolyte is 0.5 to 15% by weight of the entire wet powder.

### <Specific Example of Anode Current Collector>

As the anode current collector constituting the anode current collector layer 21b, one having the same structure as that described for the cathode current collector can be appropriately used. It also can be obtained by the same method. The anode current collector layer 21b is preferably a resin current collector from the viewpoint of battery characteristics and the like. The thickness of the anode current collector layer 21b is not particularly limited, but is preferably 5 to 150 μm.

### <Specific Examples of Anode Active Materials>

It is preferable that the anode active material layer 22b is a non-bound body of a mixture containing the anode active material. The reason why it is preferable that the anode active material layer is a non-bound body, is the same reason why it is preferable that the cathode active material layer 22a is a non-bound body. The method of obtaining the anode active material layer 22b which is a non-bound body, is the same as the method of obtaining the cathode active material layer 22a which is a non-bound body.

As the anode active material, for example, carbon-based materials, silicon-based materials, and mixtures thereof can be used, but there is no particular limitation.

The anode active material may be a coated anode active material, where at least a part of a surface of the coated anode active material is coated with a coating material containing a macromolecule compound. In a case where the outer periphery of the anode active material is covered by a coating material, the volume change of the anode is alleviated, and thus the expansion of the anode can be suppressed.

As the coating material, the same one as the coating material constituting the coated cathode active material can be suitably used.

The anode active material layer 22b contains an electrolyte and an electrolytic solution that contains a non-aqueous solvent. Regarding the composition of the electrolytic solution, an electrolytic solution similar to that contained in the cathode active material layer 22a can be suitably used.

The anode active material layer 22b may contain a conductive assistant. As the conductive assistant, a conductive material similar to the conductive filler contained in the cathode active material layer 22a can be suitably used.

The anode active material layer 22b may contain adhesive resin. As the adhesive resin, the same adhesive resin as the optional component of the cathode active material layer 22a can be suitably used.

The thickness of the anode active material layer 22b is not particularly limited, but from the viewpoint of battery performance, it is preferably 150 to 600 μm, more preferably 200 to 450 μm.

In this embodiment, a anode composition, which is supplied to form the anode active material layer 22a, is a wet powder containing an anode active material and non-aqueous electrolytic solution. Also, it is preferable that the wet powder is in a condition of pendula or funicular.

The ratio of the non-aqueous electrolytic solution in the wet powder is not particularly limited, but if the pendula or funicular condition is necessary, in terms of the anode, it is preferable that the proportion of the non-aqueous electrolyte is 0.5 to 25% by weight of the entire wet powder.

### <Specific Example of Separator>

Examples of the electrolyte held in the separator 30 include an electrolytic solution or a gel polymer electrolyte. The separator 30 ensures high lithium-ion conductivity by using these electrolytes. The form of the separator 30 includes, for example, a porous film made of polyethylene or polypropylene, but is not particularly limited.

### <Specific Example of Frame Member>

The frame member 35 is not particularly limited as long as it is made of a material that is durable against the electrolytic solution, but a polymer material is preferable, and a thermosetting polymer material is more preferable. The material constituting the frame member 35 may be any material as long as it has insulation properties, sealing properties (liquid tightness), heat resistance under the battery operating temperature, etc., and a resin material is suitably selected. Specifically, epoxy resins, polyolefin resins, polyester resins, polyurethane resins, polyvinidene fluoride resins, etc. may be used for the frame member 35.

### <Battery Electrode Manufacturing Device and Battery Electrode Manufacturing Method>

Next, a manufacturing device and a battery electrode manufacturing method (hereinafter simply referred to as a manufacturing method) of the present embodiment, will be described. For example, as for the battery electrode manufacturing device and the battery electrode manufacturing method, first, the cathode 20a and the anode 20b are manufactured. The manufacturing method for the cathode 20a and the manufacturing method for the anode 20b differ mainly in the electrode active material contained in the electrode active material layer 22. Herein, as a manufacturing method for the electrode 20, the manufacturing method for the cathode 20a and the anode 20b will be described together.

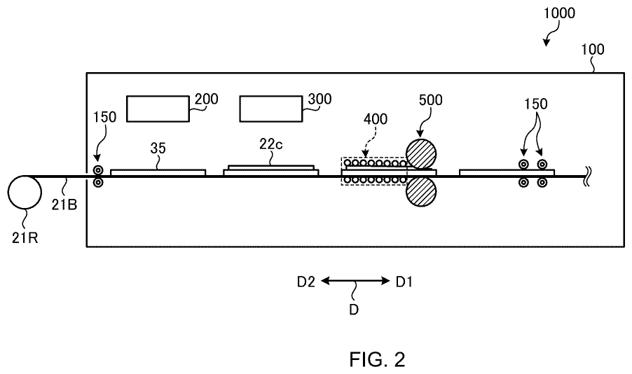

FIG. 2 is a schematic diagram showing the battery electrode manufacturing device 1000. For example, the battery electrode manufacturing device 1000 comprises a chamber 100, a conveyance mechanism 150, a frame member supply device 200, a powder supply device 300, a preliminary press device 400, and a press device 500. Herein, the conveyance mechanism 150 is an example of a conveyance unit. The powder supply device 300 is an example of a powder supply unit. The preliminary press device 400 is an example of a preliminary press unit. The press device 500 is an example of a press unit. Hereinafter, a case where the strip-shaped base film is the strip-shaped current collector 21B will be described as an example.

The chamber 100 is a room whose interior is decompressed and maintained below atmospheric pressure. The pressure inside the chamber 100 is decompressed below atmospheric pressure by a decompress pump (not shown in the figure). The standard atmospheric pressure is approximately 1013 hPa (approximately 105 Pa).

For example, the current collector roll 21R is arranged outside the chamber 100. The strip-shaped current collector 21B pulled out from the current collector roll 21R is conveyed into the chamber 100 through the slit. Hereinafter, the strip-shaped current collector 21B may be referred to as the current collector 21B. Note that the current collector 21B is the current collector 21 before being cut into a predetermined shape. The current collector 21B is conveyed along the conveying direction D. For example, the current collector 21B is conveyed at a predetermined speed by the conveyance mechanism 150. In the following description, the direction in which the current collector 21B is conveyed is referred to as the downstream side D1, and the opposite direction is referred to as the upstream side D2. Note that the external space of the chamber 100 in which the current collector roll 21R is arranged may be at normal pressure or may be reduced in pressure by a chamber, which is different from the chamber 100.

The conveyance mechanism 150 shown in FIG. 2 comprises a drive roller and a driven roller. The drive roller is arranged on the upper side of the current collector 21B. The drive roller rotates under drive control by a control device (not shown) so that the current collector 21B is conveyed to the downstream side D1 along the conveying direction D. The driven roller is arranged below the current collector 21B. The driven roller rotates according to the conveyance of the current collector 21B toward the downstream side D1 along the conveying direction D due to the rotation of the drive roller. A plurality of transport mechanisms 150 are arranged at intervals along the conveying direction D inside the chamber 100. The conveyance mechanism 150 in the most upstream side sandwiches only the current collector 21B vertically and conveys it to the downstream side D1 along the conveying direction D. The conveyance mechanism 150 in the most downstream side sandwiches at least the current collector 21B and the frame member 35 vertically and conveys them to the downstream side D1 along the conveying direction D. Note that the current collector 21B is placed on a belt conveyor (not shown). The current collector 21B and the frame member 35 are conveyed to the downstream side D1 along the conveying direction D by the conveyance mechanism 150 while being placed on the belt conveyor.

The frame member supply device 200 supplies the frame member 35 to the current collector 21B being conveyed. Note that although FIG. 2 shows a case where the frame member supply device 200 is arranged inside the chamber 100, the frame member supply device 200 may be arranged outside the chamber 100. For example, the frame member supply device 200 has a robot arm and places the frame member 35, which has been manufactured in advance, at a predetermined position on the current collector 21B being conveyed. Note that after the frame member 35 is placed on the current collector 21B, the current collector 21B and the frame member 35 may be compressed using a roll press so as to sandwich the current collector 21B and the frame member 35.

Herein, in FIG. 2, the pre-manufactured frame member 35 is placed on the current collector 21B. However, the embodiments are not limited to this. For example, the frame member 35 may be manufactured on the current collector 21B. For example, in a case when the current collector 21B is used as a substrate, the frame member 35 can be formed on the current collector 21B by discharging or applying a predetermined material in a predetermined shape onto the current collector 21B using a dispenser, coater, etc.

As shown in FIG. 2, the powder supply device 300 supplies the electrode composition 22c onto the current collector 21B conveyed in the chamber 100. As mentioned above, in this embodiment, in order to form the electrode active material layer 22 (cathode active material layer 22a, anode active material layer 22b), the electrode composition 22c (cathode composition, anode composition) supplied from the powder supply device 300 is a wet powder containing an electrode active material (cathode active material, anode active material) and an electrolytic solution (non-aqueous electrolyte). In other words, the powder supply device 300 supplies wet powder containing an electrode active material and an electrolytic solution onto the current collector 21B, which is a strip-shaped base film. Also, in this embodiment, it is preferable that the wet powder as the electrode composition 22c is in a condition of pendula or funicular. In addition, the electrode active material is a coated electrode active material coated with a coating material containing a polymer compound.

For example, the powder supply device 300 comprises a hopper that holds the electrode composition 22c as the wet powder inside, and a shutter that opens and closes the opening of the hopper. The powder supply device 300 can supply a desired amount of the electrode composition 22c onto a desired position of the current collector 21B being conveyed along the conveying direction D by opening and closing the shutter. The electrode active material contained in the electrode composition 22c is a coated electrode active material. Therefore, during the step of supplying the electrode composition 22c onto the current collector 21B, it is necessary to keep the electrode composition 22c in a soft state. The conveyance mechanism 150 described above conveys the current collector 21B carrying the electrode composition 22c (wet powder) supplied from the powder supply device 300.

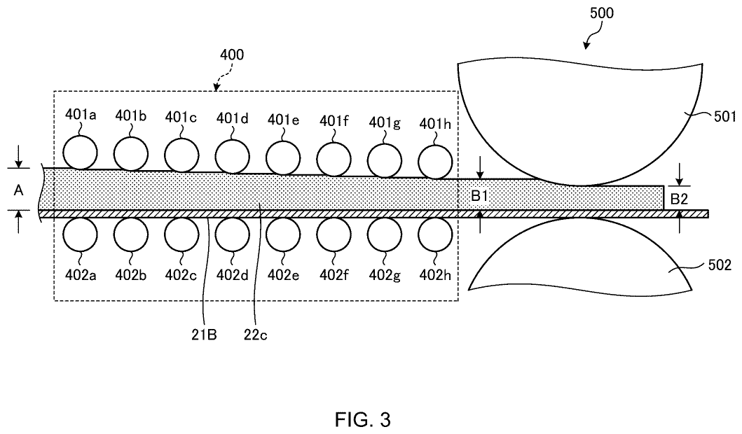

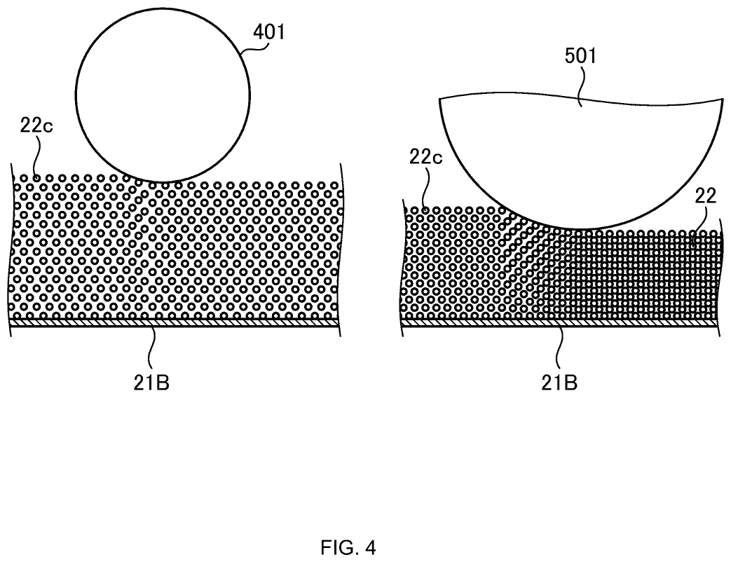

The preliminary press device 400 and the press device 500 compress the electrode composition 22c supplied onto the strip-shaped current collector 21B, which is an example of a strip-shaped base film, to form the electrode active material layer 22 shown in FIG. 1. FIG. 3 is a diagram showing the preliminary press device 400 and the press device 500 included in the battery electrode manufacturing device 1000. FIG. 4 is a diagram schematically showing the compression process of the electrode composition 22c by the preliminary press device 400 and the press device 500. It is noted that FIG. 3 is an enlarged view of the preliminary press device 400 and the press device 500 shown in FIG. 2, and the frame member 35 is omitted from the illustration.

The preliminary press device 400 comprises a pair of preliminary rollers that compress the wet powder (electrode composition 22c) supplied from the powder supply device 300 onto the current collector 21B. Herein, the preliminary press device 400 includes a plurality of pairs of preliminary rollers that compress the wet powder (electrode composition 22c) in stages. That is, the preliminary press device 400 includes at least two pairs of preliminary rollers. The preliminary press device 400 compresses the electrode composition 22c, which is placed on the current collector 21B and is the wet powder containing an electrode active material and an electrolytic solution, in stages by sandwiching the electrode composition 22c together with the current collector 21B between the pair of preliminary rollers arranged in plurality along the conveying direction D. In the example shown in FIGS. 2 and 3, the preliminary press device 400 comprises an upper preliminary roller 401a and a lower preliminary roller 402a, an upper preliminary roller 401b and a lower preliminary roller 402b, an upper preliminary roller 401c and a lower preliminary roller 402c, an upper preliminary roller 401d and a lower preliminary roller 402d, an upper preliminary roller 401e and a lower preliminary roller 402e, an upper preliminary roller 401f and a lower A preliminary roller 402f, an upper preliminary roller 401g and a lower preliminary roller 402g, an upper preliminary roller 401h and a lower preliminary roller 402h, as eight pairs of preliminary rollers. Hereinafter, in a case when the upper preliminary rollers 401a to 401h and the lower preliminary rollers 402a to 402h are not particularly distinguished, they are collectively referred to as “upper preliminary roller 401” and “lower preliminary roller 402.”

As shown in FIGS. 2 and 3, the upper preliminary roller 401 has the same diameter as the lower preliminary roller 402 forming a pair. The lower preliminary rollers 402a to 402h that contact the current collector 21B from below are arranged at the same height. On the other hand, the upper preliminary rollers 401a to 401h that contact the electrode composition 22c (wet powder) from above are arranged so as to gradually become lower from the upstream side D2 to the downstream side D1. In other words, the distance between the upper preliminary roller 401 and the lower preliminary roller 402 gradually decreases from the upstream side D2 to the downstream side D1. That is, the gap between the plurality of pairs of preliminary rollers decreases toward the downstream side D1 along the conveying direction D of the current collector 21B.

As shown in FIG. 3, the electrode composition 22c is compressed in stages from a thickness A to a thickness B1 by the preliminary press device 400. For example, the thickness A is 1000 μm, and the thickness B1 is 700 to 800 μm. In other words, the preliminary press device 400 reduces the thickness of the electrode composition 22c in eight steps from 1000 μm to 700˜800 μm. For example, preliminary press device 400 reduces the thickness of electrode composition 22c by 25-37.5 μm with each of eight roll pressings. Note that the number of the pair of preliminary rollers (upper preliminary roller 401 and lower preliminary roller 402) is not limited to eight, but may be two or more. Since the compression should be performed in stages gradually, it is preferable that there are three or more.

The press device 500 comprises a pair of rollers that compress electrode composition 22c (wet powder) after compression by the preliminary press device 400. The press device 500 compresses the electrode composition 22c (wet powder) using a pair of rollers having a larger diameter than the pair of preliminary rollers used by the preliminary press device 400. That is, the press device 500 compresses the electrode composition 22c, which compressed by the preliminary press device 400, together with the current collector 21B by sandwiching them between a pair of rollers having a larger diameter than the pair of preliminary rollers. As shown in FIGS. 2 and 3, the press device 500 comprises an upper roller 501 and a lower roller 502 as a pair of rollers. As shown in FIGS. 2 and 3, the upper roller 501 has the same diameter as the paired lower roller 502, and the diameter of the upper roller 501 is larger than the diameter of the upper preliminary roller 401. For example, the diameter of the upper preliminary roller 401 is ⅓ times or less than the diameter of the upper roller 501. Further, the distance between the upper roller 501 and the lower roller 502 is shorter than the distance between the upper preliminary roller 401h and the lower preliminary roller 402h. In other words, the gap between the pair of preliminary rollers is set to be larger than the gap between the pair of rollers. The smallest gap among the gaps between the plurality of pairs of preliminary rollers is set to be larger than the gap between the pair of rollers.

As shown in FIG. 3, the electrode composition 22c becomes the electrode active material layer 22 by being compressed from the thickness B1 to the thickness B2 by the press device 500. For example, the thickness B2 is 600 μm. That is, the press device 500 reduces the thickness of the electrode composition 22c from 700˜800 μm to 600 μm with one roll press.

In the preliminary press step by the preliminary press device 400, the electrode composition 22c placed in a soft state is compressed little by little in stages by the multistage roll press using small diameter rollers (upper preliminary roller 401, lower preliminary roller 402) while keeping the surface flat (refer to the left diagram in FIG. 4). Due to this, the gap between the electrode active materials contained in the electrode composition 22c gradually decreases, liquid bridges occur, and the electrode active materials begin to stick to each other via the polymer compound. The electrode active material will eventually be in a compacted state to some extent. In the press step using the press device 500, the compacted electrode composition 22c is uniformly compressed to a desired thickness B2 without being deformed by a single-stage roll press using large-diameter rollers (upper roller 501, lower roller 502). Eventually, the electrode active material layer 22 is formed (refer to the right diagram in FIG. 4). Note that the lower preliminary roller 402 and the lower roller 502 are omitted in FIG. 4.

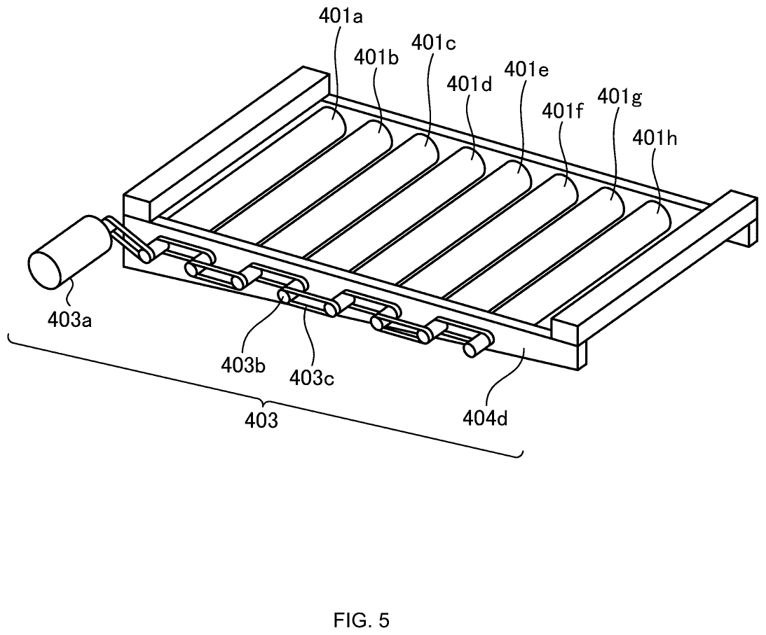

Herein, a pair of preliminary rollers included in the preliminary press device 400 are rotationally driven in accordance with conveyance along the conveying direction D of the current collector 21B as a base film. For this reason, it is preferable that the preliminary press device 400 has a rotation mechanism 403 that rotates the plurality of pairs of preliminary rollers (the upper preliminary roller 401 and the lower preliminary roller 402) in conjunction with each other. FIG. 5 is a diagram showing an example of the rotation mechanism 403 included in the preliminary press device 400.

The rotation mechanism 403 shown in FIG. 5 transmits the rotation of a geared motor 403a to each of the upper preliminary rollers 401a to 401h, which are rotatably held at a predetermined height by a holding member 403d, via a pulley 403b and a timing belt 403c. The pulley 403b is arranged to the rotating shaft of the geared motor 403a and each of the upper preliminary rollers 401a to 401h. The timing belt 403c spans each of two adjacent pulleys 403b. With this configuration, in a case when the geared motor 403a rotates, the upper preliminary rollers 401a to 401h rotate in conjunction. Note that the preliminary press device 400 has a rotation mechanism having the same configuration as the rotation mechanism 403 in order to rotate the lower preliminary rollers 402a to 402h in conjunction with each other. Herein, in order to uniformly compress the wet powder, the conveyance speed along the conveying direction D of the current collector 21B, which is the base film, and the rotational speed of the pair of preliminary rollers are synchronized within a certain range. Such synchronous control can be realized, for example, by controlling the rotational speed of the drive roller of the conveyance mechanism 150 and the rotational speed of the geared motor 403a.

After the preliminary press step and the press step, the current collector layer 21 is appropriately cut out from the strip-shaped current collector 21B, and then the electrode 20 (current collector 21, electrode active material layer 22, and frame member 35) is manufactured. Further, the single cell 10 is manufactured by stacking the pair of electrodes 20 (the cathode 20a and the anode 20b) by facing each other via the separator 30 therebetween.

As described above, in the embodiment, the preliminary press is performed in which the wet powder that is the electrode composition 22c is compressed gradually by a roll press, which makes use of a plurality of pairs of small diameter rollers (upper preliminary roller 401, lower preliminary roller 402) in order for the wet powder not to deform. Thereafter, in the embodiment, the electrode composition 22c is compressed to a desired thickness by a roll press using large diameter rollers (upper roller 501 and lower roller 502). With this, in this embodiment, the electrode active material layer 22 with high density can be formed to improve the electronic conductivity of the electrode 20.

Further, in the embodiment, the multi-stage roll press by the preliminary press device 400 is performed using the small diameter rollers having a diameter that is, for example, ⅓ or less of the diameter of the large diameter rollers. This can prevent the lines for the preliminary press step and the press step from becoming longer.

Furthermore, in the embodiment, a plurality of pairs of preliminary rollers (an upper preliminary roller 401 and a lower preliminary roller 402) are rotated in conjunction with each other. This allows the electrode composition 22c to be reliably compressed little by little.

Further, in the embodiment, the preliminary press device 400 and the press device 500 are arranged in the chamber 100 whose interior is decompressed below atmospheric pressure. By compressing the wet powder that is the electrode composition 22c under decompressed pressure, it is possible to prevent air from remaining inside the electrode composition 22c, and the uniformity of the electrode active material layer 22 can be improved. In addition, in the embodiment, by performing the multi-stage roll press using the small diameter rollers, it is possible to prevent the lines for the preliminary press process and the press process from becoming long. However, this advantage is also a great advantage from the perspective of equipment investment when electrode manufacturing is performed inside the chamber 100, which is a decompressed pressure chamber.

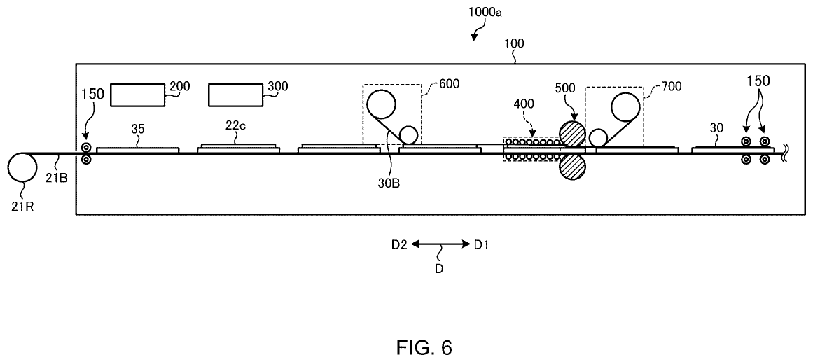

Note that the electrode composition 22c tends to adhere to the roller. However, in order to prevent this, in the embodiment, a separator 30 may be supplied on top of the electrode composition 22c, and the electrode composition 22c may be compressed by the preliminary press device 400 and the press device 500. FIG. 6 is a schematic diagram of a battery electrode manufacturing device 1000a of a first variation.

In the battery electrode manufacturing device 1000a shown in FIG. 6, a separator supply device 600 is placed between the powder supply device 300 and the preliminary press device 400. A separator collecting device 700 is arranged downstream D1 of the press device 500. The separator supply device 600 is an example of a separator supply unit.

The separator supply device 600 supplies the separator 30 to the wet powder, which is the electrode composition 22c, placed on the strip-shaped current collector 21B. For example, the separator supply device 600 comprises a separator roll and a drive mechanism that pulls the separator sheet 30B out from the separator roll. The separator supply device 600 overlaps the separator sheet 30B, which is conveyed at the same predetermined speed as the electrode composition 22c, onto the electrode composition 22c, which is conveyed at a predetermined speed along the conveying direction D. More specifically, the separator supply device 600 comprises a roller as a drive mechanism located above the electrode composition 22c being conveyed. The separator supply device 600 can supply the separator 30 onto the electrode composition 22c by pressing the separator sheet 30B against the electrode composition 22c while conveying the separator sheet 30B at a predetermined speed using said roller.

Then, the plurality of pairs of preliminary rollers and the pair of rollers compress by sandwiching the electrode composition 22c between the separator sheet 30B and the current collector 21.

The separator collecting device 700 collects the surplus portion of the separator sheet 30B. The entire separator sheet 30B is not always used as the separator 30, and there may be a portion such as an end portion of the separator sheet 30B that is not cut out as the separator 30. The separator collecting device 700 collects such surplus portions. In a case when the separator supply device 600 supplies the separators 30 to each electrode composition 22c, the battery electrode manufacturing device 1000a does not need to have the separator collecting device 700.

In the first variation described above, the electrode composition 22c is compressed by the preliminary press device 400 and the press device 500 via the separator 30 (separator sheet 30B). With this configuration, any adhesion of the electrode composition 22c to the upper preliminary roller 401, the upper roller 501 and so on can be prevented. As a result, the first variation can prevent the surface of the electrode active material layer 22 formed by compression of the electrode composition 22c from becoming uneven. Also, the first variation can prevent the amount of the electrode composition 22c contained in the electrode 20 from becoming unstable.

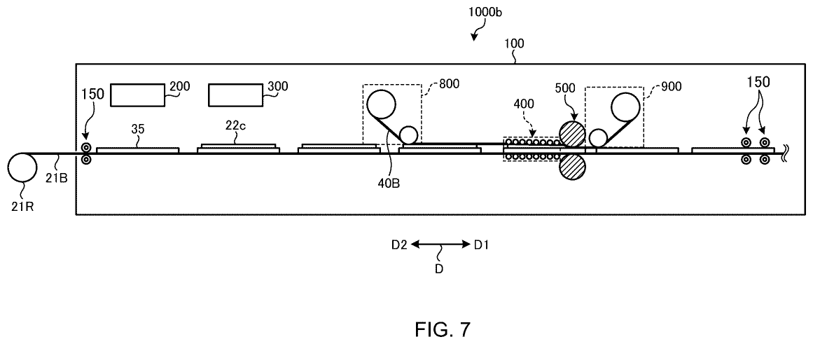

In addition, from the viewpoint of preventing the electrode composition 22c from adhering to the roller, in the embodiment, it is possible to supply a release film on the electrode composition 22c, and the electrode composition 22c is compressed by the preliminary press device 400 and the press device 500. FIG. 7 is a schematic diagram of a battery electrode manufacturing apparatus 1000b of a second variation.

In terms of the battery electrode manufacturing device 1000b shown in FIG. 7, a release film supply device 800 is placed between the powder supply device 300 and the preliminary press device 400. A release film collecting device 900 is placed downstream side D1 of the press device 500. The release film supply device 800 is an example of a release film supply unit.

The release film supply device 800 supplies the release film 40B to the electrode composition 22c, which has been stacked on the current collector 21B. Although the material of the release film 40B is not particularly limited, PET (Polyethylene terephthalate) can be used as an example. Further, a release agent may be applied to the surface of the release film 40B. For example, the release film supply device 400 comprises a release film roll in which the strip-shaped release film 40B is wound into a roll, and a drive mechanism that pulls out the release film from the release film roll. The release film supply device 400 overlaps the release film 40B on the electrode composition 22c that is conveyed at a predetermined speed along the conveying direction D while conveying the release film 40B at the same predetermined speed. More specifically, the release film supply device 400 comprises a roller located above the member sheet being conveyed as a drive mechanism. The release film supply device 3400 can supply the release film 40B to the electrode composition 22c by pressing the release film 40B against the electrode composition 22c while conveying the release film 40B at a predetermined speed using the roller.

Then, the plurality of pairs of preliminary rollers (upper preliminary roller 401 and lower preliminary roller 402) and the pair of rollers (upper roller 501 and lower roller 502) compress the electrode composition 22c by sandwiching the electrode composition 22c between the release film 40B and the current collector 21.

The release film collecting device 600 peels and collects the release film 40B, which has been compressed by the preliminary press device 400 and the press device 500, from the electrode active material layer 22. For example, the release film collecting device 600 can wind up the release film 40B after it has been compressed by the press device 500, and manage it in the form of a roll that can be easily disposed of or reused.

In the second variation described above, the electrode composition 22c is compressed by the preliminary press device 400 and the press device 500 via the release film 40B. With this configuration, an adhesion of the electrode composition 22c to the upper preliminary roller 401 and the upper roller 501 can be prevented. As a result, the second variation can prevent the surface of the electrode active material layer 22 formed by compression of the electrode composition 22c from becoming uneven. Also, it can surely prevent the amount of the electrode composition 22c contained in the electrode 20 from becoming unstable.

In addition, in the embodiment, the first variation, and the second variation described above, the case where the electrode composition 22c placed in the frame member 35 is compressed by the preliminary press device 400 and the press device 500, has been described. However, it is not limited to this. For example, the electrode composition 22c is continuously placed on the strip-shaped current collector 21B and compressed by the preliminary press device 400 and the press device 500 to form a strip-shaped electrode active material layer. Thereafter, in order for the frame member 35 to be arranged, the strip-shaped electrode active material layer may be trimmed into a rectangular electrode active material layer 22. Alternatively, a mask or other material having a space in which the electrode active material layer 22 can be formed is placed on the strip-shaped current collector 21B, and the electrode composition 22c is supplied in it. And then, the electrode composition 22c may be compressed by the preliminary press device 400 and the press device 500. In such a case, the frame member 35 is placed after the mask is removed.

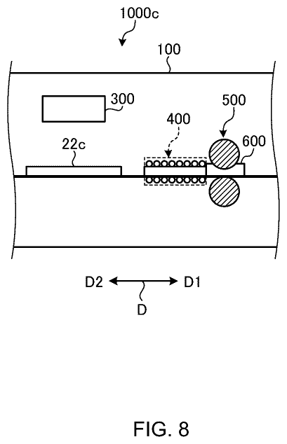

However, in a case when compressed by a roll press without being surrounded by the frame member 35, the electrode composition 22c (wet powder) may spread in the width direction, resulting in unintended dimensional changes. Therefore, in order to suppress deformation of the electrode composition 22c (wet powder) in the width direction during compression by roll press, a battery electrode manufacturing device may be configured as in the following third variation. FIG. 8 is a schematic diagram of the battery electrode manufacturing device 1000c of the third variation.

In terms of the battery electrode manufacturing device 1000c shown in FIG. 8, the electrode composition 22c (wet powder) is compressed by the preliminary press device 400 and the press device 500 without being surrounded by the frame member 35. In the third variation, the powder supply device 300 supplies the electrode composition 22c (wet powder) to the current collector 21B before the frame member 35 is supplied. The frame member supply device 200 supplies the frame member 35 to the electrode composition 22c (wet powder) compressed by the preliminary press device 400 and the press device 500. As shown in FIG. 8, a width presser 600 is installed in the battery electrode manufacturing device 1000c.

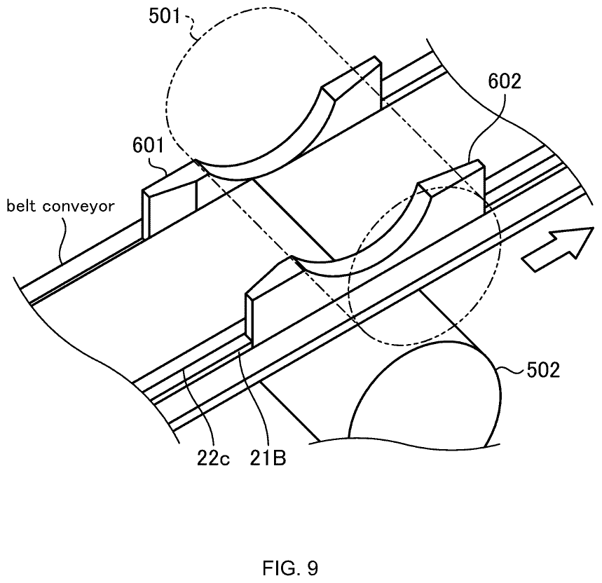

The width presser 600 suppresses the deformation of the electrode composition 22c along the width direction by contacting with both widthwise ends of the electrode composition 22c, which is supplied onto the current collector 21B, during the compression by the press device 500. That is, the press device 500 compresses the base film and the wet powder in a state where the width presser 600 is in contact with the electrode composition 22c (wet powder). FIG. 9 is a perspective view showing the width presser 600 and the press device 500 according to the third variation. Specifically, as shown in FIG. 9, the width presser 600 is located vertically above the current collector 21B and the belt conveyor that conveys the current collector 21B. The width presser 600 is in contact with the electrode composition 22c, which is conveyed along the direction shown by the arrow in FIG. 9, from both widthwise ends.

In FIG. 9, the current collector 21B and the electrode composition 22c are conveyed by the belt conveyor along the direction of the arrow, and the positions of the preliminary press device 400, the press device 500, and the width presser 600 do not change. The position of the width presser 600 is fixed by, for example, a metal fitting (not shown). The material of the width presser 600 is not particularly limited, and can be comprised of any resin material or metal. In order to suppress adhesion of the electrode composition 22c onto the width presser 600, the surface of the width presser 600 may be smoothed or a release agent may be applied onto the surface.

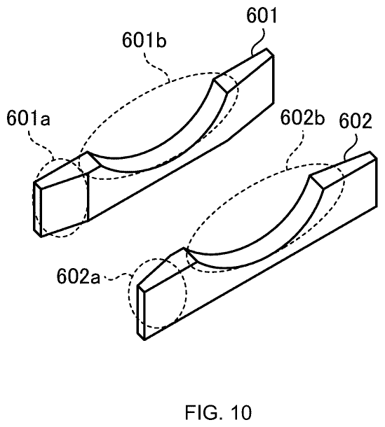

The width presser 600 will be explained more in FIG. 10. FIG. 10 is a diagram showing details of the width presser 600 according to the third variation. As shown in FIG. 10, the width presser 600 comprises a width presser 601 that contacts with one widthwise end of the electrode composition 22c, and a width presser 602 that contacts with another widthwise end of the electrode composition 22c.

Herein, the width presser 600 may comprise a drawing part for drawing the electrode composition 22c. Specifically, as shown in the opening 601a and the opening 602a in FIG. 10, the width presser 600 has an opening, which is formed on the upstream side D2 along the conveying direction D, wherein the opening has a tapered shape when viewed from the direction perpendicular to the conveying direction D and the widthwise direction. That is, the width presser 600 has an tapered opening in the upstream side D2 when viewed from above along the vertical direction. Thereby, the shape of the electrode composition 22c in the width direction can be adjusted prior to compression by the press device 500. Note that although the opening 601a and the opening 602a are shown as tapered in FIG. 10, they may have other shapes, such as an arcuate shape.

Furthermore, the width presser 600 may comprise a recess that fits with the press device 500, as shown in the recess 601b and recess 602b in FIG. 10. Specifically, in FIGS. 9 and 10, the press device 500 includes the upper roller 501 and the lower roller 502. That is, in FIGS. 9 and 10, the press device 500 includes a pair of rollers that sandwich and compress the current collector 21B and the electrode composition 22c. The width presser 600 has a recess 601b and a recess 602b that fit with the upper roller 501 when viewed from the widthwise direction. This makes it possible to reduce the gap between the press device 500 and the width presser 600 so that there is no space for the electrode composition 22c to escape. As a result, the electrode composition 22c can be efficiently compressed.

As mentioned above, the width presser 600 contacts with both widthwise ends of the electrode composition 22c. The press device 500 compresses the collector the current 21B and electrode composition 22c in a state where the width presser 600 is in contact with the electrode composition 22c. Due to this, the width presser 600 can suppress the deformation of the electrode composition 22c along the width direction when it is compressed by the roll press.

In addition, in the third variation described above, in a state where the width presser 600 is in contact with the electrode composition 22c, the preliminary press device 400 may sandwich and compress the current collector 21B and the electrode composition 22c from the direction orthogonal to the widthwise direction. In this case, the width presser 600 is designed to have a shape that corresponds to the shape and arrangement position of the plurality of upper preliminary rollers 401 of the preliminary press device 400.

Further, in the third variation described above, in a state where the width presser 600 is in contact with the electrode composition 22c, the preliminary press device 400 and the press device 500 may sandwich and compress the current collector 21B and the electrode composition 22c from the direction perpendicular to the widthwise direction. In this case, the width presser 600 is designed to have a shape that corresponds to the shapes and arrangement positions of the plurality of upper preliminary rollers 401 and the upper rollers 501.

Furthermore, in the embodiment, the first variation, the second variation, and the third variation described above, the strip-shaped base film, on which the electrode composition 22c is placed, is explained as the strip-shaped current collector 21B. However, it is not limited to this. For example, instead of the strip-shaped current collector 21B shown in FIG. 2, a strip-shaped separator sheet 30B or a strip-shaped release film 40B may be used as the base film.

Although the embodiments of this invention have been described above in detail with reference to the figures, the specific configuration is not limited to these embodiments. This invention also includes modifications, combinations, deletions, etc. of the configuration without departing from the gist of the present invention. Furthermore, it is needless to say that the configurations shown in each embodiment can be used in appropriate combinations.

1. A battery electrode manufacturing device, comprising:
a powder supply unit that supplies a wet powder containing an electrode active material and an electrolytic solution to a strip-shaped base film;
a conveyance unit that conveys the base film on which the wet powder supplied from the powder supply unit is placed;
a preliminary press unit, that includes a pair of preliminary rollers, and that compresses the wet powder supplied from the powder supply unit to the base film; and
a press unit having a pair of rollers that compress the wet powder after compression by the preliminary press unit,
wherein the preliminary press unit includes a plurality of the pair of preliminary rollers that compress the wet powder in stages, and
wherein the gap between the pair of preliminary rollers is set to be larger than the gap between the pair of rollers.

2. The battery electrode manufacturing device according to claim 1,
wherein the preliminary press unit includes at least two of the pair of preliminary rollers,
wherein the gap between the plurality of pairs of preliminary rollers decreases along the conveying direction of the base film, and
wherein the smallest gap among the gaps between the plurality of pairs of preliminary rollers is set to be larger than the gap between the pair of rollers.

3. The battery electrode manufacturing device according to claim 1,
wherein the press unit compresses the wet powder with the pair of rollers, whose diameters are larger than the diameters of the pair of preliminary rollers of the preliminary press unit.

4. The battery electrode manufacturing device according to claim 1, wherein the pair of preliminary rollers are rotationally driven in accordance with the conveyance of the base film along the conveying direction, and
wherein the preliminary press unit has a rotation mechanism that rotates the plurality of pairs of preliminary rollers in conjunction with each other.

5. The battery electrode manufacturing device according to claim 1,
wherein the conveyance speed along the conveying direction of the base film and the rotational speed of the pair of preliminary rollers are synchronized within a certain range.

6. The battery electrode manufacturing device according to claim 1, further comprising:
a separator supply unit that supplies a separator to the wet powder,
wherein the plurality of pairs of preliminary rollers and the pair of rollers compress the wet powder by sandwiching said wet powder between the separator and the base film.

7. The battery electrode manufacturing device according to claim 1,
wherein the preliminary press unit and the press unit are arranged in the chamber whose interior is decompressed below atmospheric pressure.

8. The battery electrode manufacturing device according to claim 1,
wherein the wet powder is in a condition of pendula or funicular.

9. The battery electrode manufacturing device according to claim 1, further comprising:
a width presser that contacts with both widthwise ends of the wet powder,
wherein at least one of the preliminary press unit and the press unit, compresses the base film and the wet powder in a state where the width presser is in contact with the wet powder.

10. The battery electrode manufacturing device according to claim 9,
wherein the width presser has a recess that fits with an upper roller, which is included in the pair of rollers of the press unit, when viewed from the widthwise direction.

11. The battery electrode manufacturing device according to claim 9,
wherein the width presser has an opening, which is formed on the upstream side along the conveying direction of the base film and the wet powder, wherein the opening has a tapered or arcuate shape along the widthwise direction when viewed from the direction perpendicular to the conveying direction and the widthwise direction.

12. A battery electrode manufacturing method, including:
a supply step of supplying a wet powder containing an electrode active material and an electrolytic solution to a strip-shaped base film;
a conveyance step of conveying the base film on which the wet powder supplied from the powder supply step is placed;
a preliminary press step of compressing the wet powder, which is supplied onto the base film in the supply step, by a pair of preliminary rollers; and
a press step of compressing the wet powder by a pair of rollers after compression in the preliminary press step,
wherein the preliminary press step compresses the wet powder in stages by a plurality of the pair of preliminary rollers, and
wherein the gap between the pair of preliminary rollers is set to be larger than the gap between the pair of rollers.

13. The battery electrode manufacturing method according to claim 12,
wherein at least one of the preliminary press step and the press step, sandwiches and compresses the base film and the wet powder in a state where a width presser, that contacts with both widthwise ends of the wet powder, is in contact with the wet powder from the direction perpendicular to the widthwise direction.
